(19) United States
(12) Patent Application Publication
(10) Pub. No.: US 2022/0013858 A1
(43) Pub. Date: Jan. 13, 2022

(54) METHOD FOR INSPECTING NONAQUEOUS ELECTROLYTE SECONDARY BATTERY SEPARATOR, METHOD FOR PRODUCING NONAQUEOUS ELECTROLYTE SECONDARY BATTERY SEPARATOR, DEVICE FOR INSPECTING NONAQUEOUS ELECTROLYTE SECONDARY BATTERY SEPARATOR, DEVICE FOR PRODUCING NONAQUEOUS ELECTROLYTE SECONDARY BATTERY SEPARATOR, AND NONAQUEOUS ELECTROLYTE SECONDARY BATTERY SEPARATOR

(71) Applicant: Sumitomo Chemical Company, Limited, Tokyo (JP)

(72) Inventors: Shun NAKAZAWA, Niihama-shi (JP); Yuki YONEGUCHI, Niihama-shi (JP); Yoshinori SATO, Niihama-shi (JP); Atsuhiro TAKATA, Osaka (JP)

(21) Appl. No.: 17/371,737

(22) Filed: Jul. 9, 2021

(30) Foreign Application Priority Data
Jul. 10, 2020 (JP) 2020-119338

(51) Int. Cl. H01M 50/417; H01M 50/403; G01B 11/06

(52) U.S. Cl. CPC H01M 50/417; G01B 11/0683; H01M 50/403

(57) ABSTRACT

An inspection method with which a separator having improved quality can be efficiently obtained is provided. The inspection method is a method for inspecting a nonaqueous electrolyte secondary battery separator that includes a polyolefin porous film. The inspection method includes a step of detecting a defect in the polyolefin porous film with the use of a color camera.

This Nonprovisional application claims priority under 35 U.S.C. § 119 on Patent Application No. 2020-119338 filed in Japan on Jul. 10, 2020, the entire contents of which are hereby incorporated by reference.

### TECHNICAL FIELD

The present invention relates to: a method for inspecting a nonaqueous electrolyte secondary battery separator; a method for producing a nonaqueous electrolyte secondary battery separator; a device for inspecting a nonaqueous electrolyte secondary battery separator; a device for producing a nonaqueous electrolyte secondary battery separator; and a nonaqueous electrolyte secondary battery separator.

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries. As a member of such a nonaqueous electrolyte secondary battery, a separator is under development.

Meanwhile, Patent Literature 1 discloses a film measuring device for measuring the thickness of a microporous film. The film measuring device includes an image pickup section for converting a color tone of a color image obtained by shooting the microporous film into gradation data of respective color components.

### CITATION LIST

### Patent Literature

[Patent Literature 1]

Japanese Patent Application Publication Tokukai No. 2007-66821

### SUMMARY OF INVENTION

### Technical Problem

However, a conventional technique such as that described above relates to a film measuring device which measures merely the thickness of a porous film, and has room for improvement in terms of efficient production of a separator having improved quality.

An object of an aspect of the present invention is to achieve an inspection method that makes it possible to efficiently obtain a separator having improved quality.

### Solution to Problem

In order to attain the object, the inventors of the present invention conducted diligent research, and, as a result, found that a separator having improved quality can be efficiently obtained by detecting defects with use of a color camera. The present invention was thus achieved. The present invention includes the following aspects.

<1> A method for inspecting a nonaqueous electrolyte secondary battery separator that includes a polyolefin porous film, the method including the step of: detecting a defect in the polyolefin porous film with use of a color camera.

<2> The method described in <1>, in which it is determined whether or not at least one selected from the group consisting of hue, chroma, and lightness of the defect that is detected in the detecting falls within a predetermined range.

<3> The method described in <2>, in which it is determined whether or not a region of the defect that is detected in the detecting, which region transmits light therethrough in an amount of not less than a predetermined threshold, has an area falling within a predetermined range.

<4> A method for producing a nonaqueous electrolyte secondary battery separator, the method including the step of: detecting a defect by the method described in any one of <1>to <3>; and removing the defect.

<5> An inspection device which inspects a nonaqueous electrolyte secondary battery separator including a polyolefin porous film, the inspection device including: a detecting section which detects a defect in the polyolefin porous film with use of a color camera.

<6> The inspection device described in <5>, further including: a determining section which determines whether or not at least one selected from the group consisting of hue, chroma, and lightness of the defect that is detected by the detecting section falls within a predetermined range.

<7> The inspection device described in <6>, in which the determining section determines whether or not a region of the defect that is detected by the detecting section, which region transmits light therethrough in an amount of not less than a predetermined threshold, has an area falling within a predetermined range.

<8> A nonaqueous electrolyte secondary battery separator production device including: the inspection device described in any one of <5>to <7>.

<9> A nonaqueous electrolyte secondary battery separator including: a polyolefin porous film in which the number of defects satisfying the following (i) to (iv) is equal to or more than 0 and less than 2 per square meter:
(i) hue, represented in values of 0 to 359 in an HSV color space that represents red as 0 and light blue as 180, is 10 to 49.
(ii) chroma, represented in values of 0 to 100 in an HSV color space that represents an achromatic color as 0 and a pure color as 100, is 25 to 58.
(iii) lightness, represented in values of 0 to 100 in an HSV color space that represents darkest black as 0 and brightest white as 100, is 30 to 50.
(iv) an area of the following region is not less than 1 μm²: a region that transmits light in an amount of not less than 40 on a brighter side, in terms of an 8-bit grayscale where the brighter side and a darker side are each represented in 127 levels with 0 being a center of the 256 levels.
<10> A nonaqueous electrolyte secondary battery separator including: a polyolefin porous film which contains, more inwardly than an outer surface, a defect containing a void that has a size of 10 μm to 400 μm.

<11> A nonaqueous electrolyte secondary battery laminated separator including: the nonaqueous electrolyte secondary battery separator described in <9>or <10>; and a porous layer which is formed on at least one surface of the nonaqueous electrolyte secondary battery separator and which contains at least one resin selected from the group consisting of a (meth)acrylate-based resin, a fluorine-containing resin, a polyamide-based resin, a polyimide-based resin, a polyester-based resin, and a water-soluble polymer.

<12> The nonaqueous electrolyte secondary battery laminated separator described in <11>, in which the polyamide-based resin is an aramid resin.

### Advantageous Effects of Invention

With an aspect of the present invention, it is possible to provide an inspection method with which a separator having improved quality can be efficiently obtained.

### BRIEF DESCRIPTION OF DRAWINGS

FIG. 1 is a view schematically illustrating a nonaqueous electrolyte secondary battery separator inspection method and a nonaqueous electrolyte secondary battery separator production method in accordance with an embodiment of the present invention.

FIG. 2 is a view schematically illustrating a nonaqueous electrolyte secondary battery separator inspection device and a nonaqueous electrolyte secondary battery separator production device in accordance with an embodiment of the present invention.

FIG. 3 is a view illustrating an image of a black defect in accordance with an embodiment of the present invention and schematically illustrating a cross section of the black defect.

FIG. 4 is a view illustrating an image of a red defect in accordance with an embodiment of the present invention and schematically illustrating a cross section of the red defect.

FIG. 5 is a view illustrating an image of a red-white defect in accordance with an embodiment of the present invention and schematically illustrating a cross section of the red-white defect.

FIG. 6 is a view illustrating an image of a white defect in accordance with an embodiment of the present invention and schematically illustrating a cross section of the white defect.

FIG. 7 is a view schematically illustrating a cross section of a bright-white defect in accordance with an embodiment of the present invention.

### DESCRIPTION OF EMBODIMENTS

The following description will discuss embodiments of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by combining technical means disclosed in differing embodiments.

Any numerical range expressed as “A to B” herein means “not less than A and not more than B” unless otherwise stated. A “machine direction” (MD) as used herein means a direction in which a polyolefin porous film is conveyed. A “transverse direction” (TD) means a direction which is perpendicular to the MD and which is parallel to the surface of the polyolefin porous film.

[1. Method for Inspecting Nonaqueous Electrolyte Secondary Battery Separator]

An inspection method in accordance with an embodiment of the present invention is a method for inspecting a separator for a nonaqueous electrolyte secondary battery (hereinafter referred to as a “nonaqueous electrolyte secondary battery separator”) that includes a polyolefin porous film, the method including the step of detecting, with use of a color camera, a defect in the polyolefin porous film.

A nonaqueous electrolyte secondary battery separator may also be referred to simply as a “separator” herein. A polyolefin porous film may also be referred to simply as a “porous film”.

The porous film contains a polyolefin-based resin as a main component and has therein many pores connected to one another, so that gas and liquid can pass through the porous film from one surface to the other. The porous film contains the polyolefin-based resin at a proportion of not less than 50% by volume, preferably not less than 90% by volume, and more preferably not less than 95% by volume, relative to the entire porous film.

A porous film may contain a defect resulting from the inclusion of a foreign substance, the occurrence of a void, a burnt resin, or the like during production of the porous film. The defect may or may not affect the physical properties of a separator. When a separator having desired physical properties is to be obtained, it is preferable to remove defects that may have adverse effects. If, for example, a defect does not affect the safety of a separator, then, in terms of productivity, it may be preferable not to remove the defect. However, in an inspection method in which a monochromatic camera is used, it is difficult to distinguish these defects. In contrast, with the inspection method in accordance with an embodiment of the present invention, it is possible to easily distinguish various defects by detecting the defects with use of a color camera. This makes it possible to efficiently produce a separator having improved quality.

In a detecting step, a color camera is used to obtain an image. Examples of the color camera encompass, but are not particularly limited to, a CCD camera and a CMOS camera.

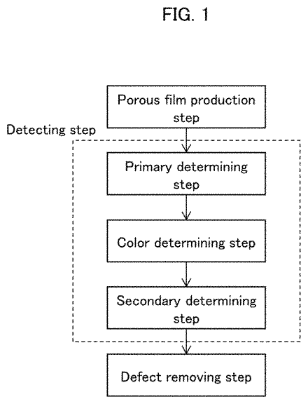

FIG. 1 is a view schematically illustrating a nonaqueous electrolyte secondary battery separator inspection method and a nonaqueous electrolyte secondary battery separator production method in accordance with an embodiment of the present invention.

First, the detecting step can include a primary determining step. In the primary determining step, before the color information of a defect is obtained, a candidate for the defect, the color information of which is to be obtained, is detected. For example, a defect can be detected on the basis of the amount of light that is transmitted. In addition, a threshold can be set at either or both of a side where the light transmission amount is large (brighter side) and/or a side where the light transmission amount is small (darker side). For example, the variance in the light transmission amount is represented by the brightness defined by an 8-bit grayscale. That is, the brightness is represented in 256 levels. The brighter side and the darker side are each represented in 127 levels, with 0 being the center of the 256 levels. It is possible to detect 40 or more bright defects on the brighter side and/or 40 or more dark defects on the darker side. It is also possible to detect a defect having both of a region where the light transmission amount is large and a region where the light transmission amount is small.

In the primary determining step, it is possible to binarize detected defects and, on the basis of size, extract defects. The “size” is, for example, the lengths, of a defect, in the MD and the TD of a porous film and the area of the defect. Specifically, it is possible to extract a defect having a length of not shorter than 100 μm in the MD of the porous film and having a length of not shorter than 50 μm in the TD of the porous film.

The detecting step can include a color determining step. In the color determining step, the color information of the defect is obtained. Examples of the color information encompass hue, chroma, and lightness. For example, hue, chroma, and lightness are represented by the Munsell color system used in JIS Z8721, which is the color specification method, that is, the specification based on three attributes. However, this example is non-limiting, and various color systems and color spaces can be used. For example, hue, chroma, and lightness can be represented by the HSV color space.

The detecting step can include a secondary determining step. In the secondary determining step, the types of defect are distinguished on the basis of the color information. For example, in the secondary determining step, it is possible to determine whether or not at least one selected from the group consisting of the hue, chroma, and lightness of a defect falls within a predetermined range. Preferably, in the secondary determining step, it is determined whether or not all of the hue, chroma, and lightness of the defect fall within the predetermined range. In addition, in the secondary determining step, it can be determined whether or not the area of a region of a defect, where a light transmission amount is not less than a predetermined threshold, falls within a predetermined range.

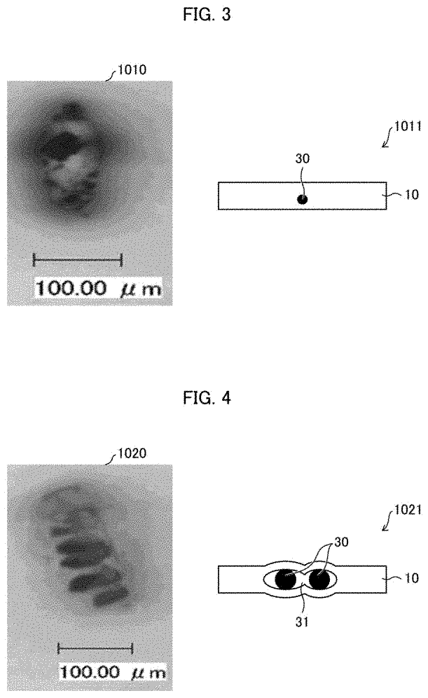

For convenience, the types of defects are herein categorized into black defect, red defect, red-white defect, white defect, and bright-white defect. FIGS. 3 to 7 are views showing examples of these defects.

FIG. 3 includes: an image 1010 of a black defect, which is captured from a direction perpendicular to a surface of a porous film; and an outline 1011 of a cross section, of the black defect, which is perpendicular to the surface of the porous film. The black defect is caused by a foreign substance 30 that is present in the porous film 10.

FIG. 4 includes: an image 1020 of a red defect, which is captured from a direction perpendicular to a surface of a porous film; and an outline 1021 of a cross section, of the red defect, which is perpendicular to the surface of the porous film. The red defect is caused by foreign substances 30 that are present in the porous film 10 and by a void 31 that is made in the vicinity of the foreign substances 30.

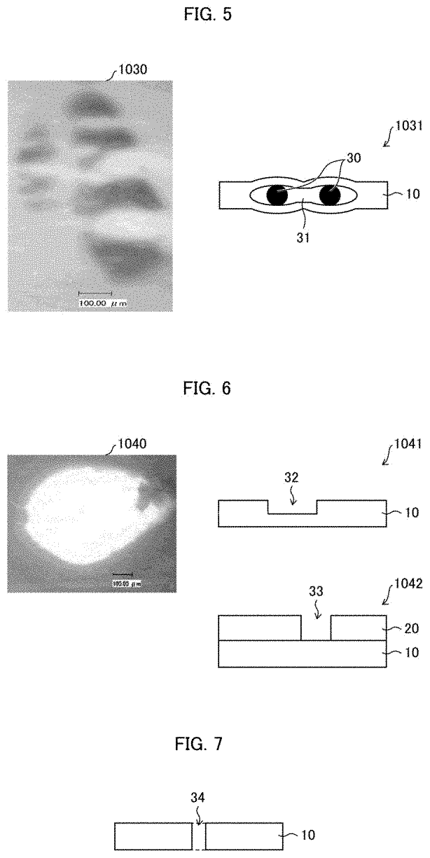

FIG. 5 includes: an image 1030 of a red-white defect, which is captured from a direction perpendicular to a surface of a porous film; and an outline 1031 of a cross section, of the red-white defect, which is perpendicular to the surface of the porous film. The red-white defect is caused by foreign substances 30 that are present in the porous film 10 and by a void 31 that is made in the vicinity of the foreign substances 30, and the void 31 is relatively large.

FIG. 6 includes: an image 1040 of a white defect, which is captured from a direction perpendicular to a surface of a porous film; and outlines 1041 and 1042 of a cross section, of the white defect, which is perpendicular to the surface of the porous film. The white defect may be caused by a thin layer part 32 that is made in the porous film 10 as illustrated in the outline 1041 of the cross section. The white defect may be caused by a region 33 where a part of a porous layer 20 formed on the porous film 10 as illustrated in outline 1042 of the cross section is peeled.

FIG. 7 is a view schematically illustrating a cross section, of a bright-white defect, which is perpendicular to a surface of a porous film. The bright-white defect is caused by a pinhole 34 that is made in the porous film 10. The pinhole 34 passes through the porous film 10 in a direction perpendicular to the surface of the porous film 10.

According to conventional monochromatic cameras, (i) black defects, red defects, and red-white defects are merely recognized as “dark defects” having small light transmission amounts and (ii) white defects and bright-white defects are merely recognized as “bright defects” having large light transmission amounts. Of these defects, white defects and bright-white defects may result in a short circuit. In contrast, black defects and red defects are unlikely to result in a short circuit. Note that red-white defects have large voids, and therefore may result in a short circuit. With a monochromatic camera, it is not possible to distinguish between (i) black defects and red defects that are unlikely to result in a short circuit and (ii) red-white defects that are likely to result in a short circuit. This causes the black defects and the red defects, which are unlikely to result in a short circuit, to be also targets to be removed, and therefore poses a problem in terms of product yield.

With an inspection method in accordance with an embodiment of the present invention, it is possible to distinguish these defects by using a color camera. For example, the following defect is identified as a red defect: a defect in which hue, chroma, and lightness each fall within a predetermined range and in which the area of a region having a light transmission amount that is not less than a predetermined threshold is less than a predetermined numerical value. The “area of a region having a light transmission amount that is not less than a predetermined threshold” is herein also called “bright area”. The bright area mainly reflects the size of each of the voids 31 described in FIGS. 4 and 5 above. The following defect is identified as a red-white defect: a defect which exhibits hue, chroma, and lightness each falling within a range identical to those in the case of the red defect and in which the bright area is not less than a predetermined numerical value. The following dark defect is identified as a black defect: a dark defect in which hue, chroma, and lightness do not satisfy the values of those in the case of the red defect and in which a light transmission amount is not less than a threshold set at the darker side. The following bright defect is identified as a white defect or as a bright-white defect: a bright defect in which hue, chroma, and lightness do not satisfy the values of those in the case of the red defect and in which a light transmission amount is not less than a threshold set at the brighter side.

A more concrete example will be discussed below. For example, hue, chroma, and lightness are represented by the HSV color space. For example, the hue is represented in values of 0 to 359 that are obtained by dividing a hue circle into 36 hues and further dividing each of 36 hues into 10 values, where red is 0 and light blue is 180. The “red” corresponds to (255, 0, 0) in the RGB color space. The “light blue” corresponds to (0, 255, 255) in the RGB color space, and is also called “cyan”. The chroma is represented in numerical values of 0 to 100, where the achromatic color is 0, and the pure color is 100. The lightness is represented in values of 0 to 100, where the darkest black is 0, and the brightest white is 100. The hue of the red defect is set at preferably 20 to 49 and more preferably 10 to 49. The chroma of the red defect is set at preferably 25 to 58. The lightness of the red defect is set at preferably 30 to 50. Furthermore, in a defect, the area that exhibits a value of not less than 40 on the brighter side in terms of brightness defined by the 8-bit grayscale described in the primary determining step above is regarded as the bright area. It is possible to regard, as a red-white defect, a defect in which (i) hue, chroma, and lightness satisfy these values and (ii) the bright area is not less than 1 μm². The hue, chroma, lightness, and bright area can be measured with use of MaxEye.Color manufactured by FUTEC INC.

The color camera can obtain an image while a porous film is being conveyed or while the conveying of the porous film is stopped. When a porous film is conveyed, the conveyance speed is preferably 1 m/min to 100 m/min and more preferably 10 m/min to 50 m/min. The porous film can be in the form of a long film or in the form of sheets.

An object to be inspected in the inspection method in accordance with an embodiment of the present invention can be a laminated film that is obtained by coating a porous film with a coating solution. Preferably, the object is a porous film without coating with a coating solution. Specifically, the object to be inspected can be a laminated film that is obtained by forming the later-described porous layer on the porous film. However, the object to be inspected is preferably a porous film without the porous layer formed thereon. When the object to be inspected is a porous film without the porous layer formed thereon, a defect can be easily detected from in the object in the inspection method in accordance with an embodiment of the present invention.

[2. Method for Producing Nonaqueous Electrolyte Secondary Battery Separator]

A nonaqueous electrolyte secondary battery separator production method in accordance with an embodiment of the present invention includes the step of detecting a defect by the above-described inspection method and removing the defect. This step of removing the defect is also referred to as “defect removing step”. In other words, the production method includes the above-described detecting step and the defect removing step.

A defect to be removed can be set as appropriate according to desired physical properties of a separator. In terms of reduction in effect on a short circuit, the red-white defects, the white defects, and the bright-white defects are preferably removed. In particular, in terms of improvement in voltage withstand characteristics, the red-white defects are preferably removed. Note that “removal of a defect” herein encompasses (i) cutting off a region of a porous film, which region contains the defect and (ii) discarding a porous film containing the defect.

The production method can include a porous film production step before the detecting step as illustrated in FIG. 1. The porous film production step includes, for example, a kneading step, a rolling step, a pore forming agent removing step, and a stretching step. The kneading step is, for example, a step in which a polyolefin-based resin is kneaded together with a pore forming agent such as an inorganic bulking agent or a plasticizer, and optionally with another agent(s) such as an antioxidant, so as to produce a polyolefin resin composition. The rolling step is a step in which the produced polyolefin resin composition is rolled with use of a reduction roller so as to form a sheet. The pore forming agent removing step is a step in which the pore forming agent is removed from the sheet with use of a suitable solvent. The stretching step is a step in which the sheet, from which the pore forming agent is removed, is stretched with use of a suitable stretch ratio so as to produce a polyolefin porous film.

The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because such a high molecular weight component improves the strength of a resultant nonaqueous electrolyte secondary battery separator.

Examples of the polyolefin-based resin (thermoplastic resin) encompass a homopolymer or a copolymer each produced by polymerizing a monomer such as ethylene, propylene, 1-butene, 4-methyl-1-pentene, and 1-hexene. Examples of the homopolymer encompass polyethylene, polypropylene, and polybutene. Examples of the copolymer encompass an ethylene-propylene copolymer.

Among the above examples, the thermoplastic resin is more preferably polyethylene as it is capable of preventing a flow of an excessively large electric current at a lower temperature. Examples of the polyethylene encompass low-density polyethylene, high-density polyethylene, linear polyethylene (ethylene-α-olefin copolymer), and ultra-high molecular weight polyethylene having a weight-average molecular weight of not less than 1,000,000. Among these examples, the polyethylene is preferably ultra-high molecular weight polyethylene having a weight-average molecular weight of not less than 1,000,000. As the thermoplastic resin, ultra-high molecular weight polyethylene and low molecular weight polyethylene having a weight-average molecular weight of not more than 10,000 can be used in combination.

Examples of the inorganic bulking agent encompass inorganic fillers; one specific example is calcium carbonate. The plasticizing agent is exemplified by a low molecular weight hydrocarbon such as liquid paraffin.

The porous film has a thickness of preferably 4 μm to 40 μm, more preferably 5 μm to 30 μm, and even more preferably 6 μm to 15 μm.

A weight per unit area of the porous film can be set as appropriate in view of strength, thickness, weight, and handleability. Note, however, that the weight per unit area of the porous film is preferably 4 g/m² to 20 g/m², more preferably 4 g/m² to 12 g/m², and even more preferably 5 g/m² to 10 g/m², so as to allow the nonaqueous electrolyte secondary battery to have a higher weight energy density and a higher volume energy density.

The production method can include a porous layer production step after the porous film production step. The above-described detecting step can be carried out before or after the porous layer production step. The porous layer can be provided on one surface of the porous film or on both surfaces of the porous film. The porous layer is preferably an insulating porous layer.

The porous layer can be formed with use of a coating solution which is obtained by (i) dissolving or dispersing resin in a solvent and (ii) dispersing a filler in the solvent. For example, the porous layer can be formed by coating the surface of the porous film with the coating solution and then removing the solvent. The solvent can be described as both a solvent in which the resin is dissolved and a dispersion medium in which the resin or filler is dispersed. Examples of a method for forming the coating solution encompass a mechanical stirring method, an ultrasonic dispersion method, a high-pressure dispersion method, and a media dispersion method.

Examples of the resin encompass a (meth)acrylate-based resin, a fluorine-containing resin, a polyamide-based resin, a polyimide-based resin, a polyester-based resin, and a water-soluble polymer. As the polyamide-based resin, aramid resins such as aromatic polyamide and wholly aromatic polyamide are preferable.

Specific examples of the aramid resins encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. As the aramid resin, poly(paraphenylene terephthalamide) is more preferable.

Examples of the filler encompass organic fine particles and inorganic fine particles. Examples of the organic fine particles encompass fine particles made of the above-described resin. Examples of the inorganic fine particles encompass fine particles made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass.

The amount of filler contained in the porous layer is preferably 10% by weight to 99% by weight, and more preferably 20% by weight to 95% by weight with respect to the total weight of the porous layer. If the amount of filler contained falls within the above ranges, it is possible to achieve sufficient ion permeability and to improve the mechanical properties and the heat resistance of the porous layer.

Examples of the solvent encompass N-methyl-2-pyrrolidone, N,N-dimethylacetamide, N,N-dimethylformamide, acetone, alcohols (such as isopropyl alcohol or ethanol), water, and a mixed solvent containing two or more of these examples.

The coating solution can be applied by a publicly known conventional method. Specific examples of the method encompass a gravure coater method, a dip coater method, a bar coater method, and a die coater method.

If the coating solution contains an aramid resin, the aramid resin can be deposited by applying humidity to the coating surface. The porous layer can be formed in this way.

The production method can include the step of cleaning the porous film and the porous layer deposited on the porous film. If the porous layer contains the aramid resin, for example, water, an aqueous solution, or an alcohol-based solution is suitably used as a cleaning liquid.

The production method can further include a drying step in which the porous layer that has been cleaned is dried. The drying can be carried out by hot air drying or roller heating.

[3. Device for Inspecting Nonaqueous Electrolyte Secondary Battery Separator]

An inspection device in accordance with an embodiment of the present invention inspects a nonaqueous electrolyte secondary battery separator that includes a polyolefin porous film, the inspection device including a detecting section which detects, with use of a color camera, a defect in the polyolefin porous film.

The detecting section includes at least a color camera. The color camera can be provided so as to be able to capture an image of a surface of a porous film to be inspected. The detecting section can include a light source that irradiates the porous film with light.

The inspection device can include a determining section which determines whether or not at least one selected from the group consisting of hue, chroma, and lightness of the defect that is detected falls within a predetermined range. As an example of the determining section, the following can be included: (i) a primary determining section which detects, from an image obtained by the color camera, a candidate for the defect, the color information of which is to be obtained; (ii) a color determining section which obtains the color information of the defect; and (iii) a secondary determining section which distinguishes the type of the defect on the basis of the color information. For example, the determining section determines whether or not at least one selected from the group consisting of hue, chroma, and lightness of the defect falls within a predetermined range. In addition, the determining section can determine whether or not the area of a region of the defect, where a light transmission amount is not less than a predetermined threshold, falls within a predetermined range. The above determination can be realized by a logic circuit (hardware) provided in an integrated circuit (IC chip) or the like or can be realized by a processor executing a program (software).

The inspection device can further include a display section which displays, for example, (i) the color information of the defect and (ii) the results of distinguishing the type of the defect. The inspection device can further include a conveyance roller which conveys a porous film.

[4. Device for Producing Nonaqueous Electrolyte Secondary Battery Separator]

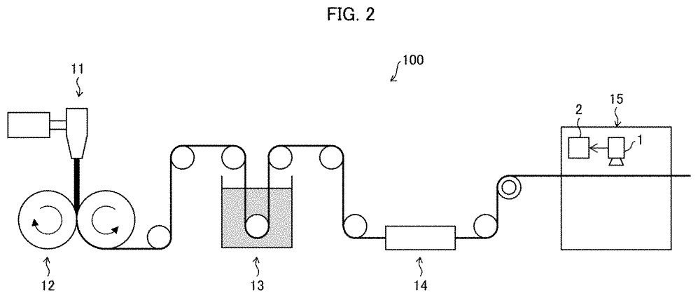

A nonaqueous electrolyte secondary battery separator production device in accordance with an embodiment of the present invention includes the above-described inspection device. FIG. 2 is a view schematically illustrating the nonaqueous electrolyte secondary battery separator inspection device and the nonaqueous electrolyte secondary battery separator production device in accordance with an embodiment of the present invention. As illustrated in FIG. 2, the production device 100 can include: a kneading device 11 which carries out the above-described kneading step; a rolling device 12 which carries out the above-described rolling step; a pore forming agent removing device 13 which carries out the above-described pore forming agent removing step; a stretching device 14 which carries out the above-described stretching step; and an inspection device 15 having a color camera 1 corresponding to the above-described color camera and a determining section 2 corresponding to the above-described determining section.

A polyolefin resin composition that is extruded from the kneading device 11 is rolled by the rolling device 12 so as to be formed into a sheet. In the pore forming agent removing device 13, a pore forming agent is removed from the sheet with use of a suitable solvent. In the stretching device 14, the sheet, from which the pore forming agent is removed, is stretched with use of a suitable stretch ratio so as to produce a porous film. The inspection device 15 detects a defect in the porous film thus produced. The conveyance roller can be used for conveying the sheet and the polyolefin porous film.

A defect removing device which carries out the above-described defect removing step can be provided downstream of the inspection device 15. The defect removing device can include, for example, a cutter that cuts off a region of the porous film, which region contains the defect.

Furthermore, a coating device which applies a coating solution for forming a porous layer on the porous film can be provided upstream or downstream of the inspection device 15.

[5. Nonaqueous Electrolyte Secondary Battery Separator]

A nonaqueous electrolyte secondary battery separator in accordance with an embodiment of the present invention includes a polyolefin porous film in which the number of defects satisfying the following (i) to (iv) is equal to or more than 0 and less than 2 per square meter:
(i) hue, represented in values of 0 to 359 in an HSV color space that represents red as 0 and light blue as 180, is 10 to 49.
(ii) chroma, represented in values of 0 to 100 in an HSV color space that represents an achromatic color as 0 and a pure color as 100, is 25 to 58.
(iii) lightness, represented in values of 0 to 100 in an HSV color space that represents darkest black as 0 and brightest white as 100, is 30 to 50.
(iv) an area of the following region is not less than 1 μm²: a region that transmits light in an amount of not less than 40 on a brighter side, in terms of an 8-bit grayscale where the brighter side and a darker side are each represented in 127 levels with 0 being a center of the 256 levels.

A defect satisfying the above (i) to (iv) corresponds to the above-described red-white defect. The inventors of the present invention found that it is possible to provide a separator having improved quality by using a polyolefin porous film in which the number of red-white defects is equal to or more than 0 and less than 2 per square meter. Specifically, such a separator has improved voltage withstand characteristics. In addition, the separator can be produced by a production method including the above-described inspection method in which the color camera is used. With an inspection using a monochromatic camera, it is not possible to recognize red-white defects, and was therefore not possible to obtain such a separator.

In addition, the nonaqueous electrolyte secondary battery separator in accordance with an embodiment of the present invention can include a polyolefin porous film which contains, more inwardly than an outer surface, a defect containing a void that has a size of 10 μm to 400 μm. Such a defect, which contains a void more inwardly than an outer surface, cannot be recognized by an inspection using a monochromatic camera. A separator, which contains, more inwardly than an outer surface, a defect having a void that satisfies the above numerical range, exhibits acceptable voltage withstand characteristics, regardless of the presence of the defect. Such a separator can also be produced by a production method including the above-described inspection method in which the color camera is used.

The porous film has an air permeability of preferably 30 s/100 mL to 500 s/100 mL, and more preferably 50 s/100 mL to 300 s/100 mL, in terms of Gurley values. A porous film having the above air permeability can achieve sufficient ion permeability.

The porous film has a porosity of preferably 20% by volume to 80% by volume, and more preferably 30% by volume to 75% by volume, so as to (i) retain an electrolyte in a larger amount and (ii) obtain a function of reliably preventing a flow of an excessively large electric current at a lower temperature. Further, in order to achieve sufficient ion permeability and prevent particles from entering the positive electrode and/or the negative electrode, the porous film has pores each having a pore size of preferably not more than 0.3 μm, and more preferably not more than 0.14 μm.

[6. Nonaqueous Electrolyte Secondary Battery Laminated Separator]

A laminated separator for a nonaqueous electrolyte secondary battery (hereinafter referred to as a “nonaqueous electrolyte secondary battery laminated separator”) in accordance with an embodiment of the present invention includes: the above-described nonaqueous electrolyte secondary battery separator; and a porous layer which is formed on at least one surface of the nonaqueous electrolyte secondary battery separator and which contains at least one resin selected from the group consisting of a (meth)acrylate-based resin, a fluorine-containing resin, a polyamide-based resin, a polyimide-based resin, a polyester-based resin, and a water-soluble polymer. A nonaqueous electrolyte secondary battery laminated separator may also be referred to simply as a “laminated separator” herein. The number of the porous layers can be one, two, or more. The porous layer is preferably an insulating porous layer.

The porous layer has a thickness (per one porous layer) of preferably 0.5 μm to 10 μm, and more preferably 1 μm to 8 μm, in terms of achieving battery safety and a high energy density. The porous layer having a thickness of not less than 0.5 μm (per one porous layer) makes it possible to sufficiently prevent an internal short circuit caused by e.g. damage to the nonaqueous electrolyte secondary battery, and also to retain a sufficient amount of the electrolyte in the porous layer. Setting the thickness of the porous layer to be not more than 10 μm (per one porous layer) decreases resistance to lithium ion permeation in the nonaqueous electrolyte secondary battery and therefore makes it possible to reduce a decrease in a rate characteristic and cycle characteristic. Setting the thickness of the porous layer to be less than 10 μm (per one porous layer) also reduces an increase in distance between the positive electrode and negative electrode, and therefore makes it possible to reduce a decrease in the internal volume efficiency of the nonaqueous electrolyte secondary battery.

A weight per unit area of the porous layer can be set as appropriate in view of strength, thickness, weight, and handleability of the porous layer. The weight per unit area of the porous layer is preferably 0.5 g/m² to 10.0 g/m², more preferably 0.5 g/m² to 8.0 g/m², and even more preferably 0.5 g/m² to 5.0 g/m² per one porous layer. A porous layer having a weight per unit area within the above numerical ranges allows a nonaqueous electrolyte secondary battery including the porous layer to have a higher weight energy density and a higher volume energy density. A porous layer whose weight per unit area exceeds the above ranges tends to cause a nonaqueous electrolyte secondary battery to be heavy.

The porous layer has a porosity of preferably 20% by volume to 90% by volume, and more preferably 30% by volume to 80% by volume, in order to achieve sufficient ion permeability. The pores in the porous layer have a diameter of preferably not more than 0.1 μm, and more preferably not more than 0.07 μm. When the pores each have such a diameter, the porous layer can achieve sufficient ion permeability in a nonaqueous electrolyte secondary battery.

### EXAMPLES

The present invention will be described below in more detail with reference to Examples and Comparative Examples. Note, however, that the present invention is not limited to such Examples.

[1. Analysis of Inspection Method]

### Production Example 1

A porous film was prepared by, as described in Japanese Patent No. 5476844, (i) adding a pore forming agent to a polyolefin-based resin, (ii) forming the polyolefin-based resin into a film, and (iii) removing the pore forming agent.

Specifically, the porous film was formed by a production method including the following steps:
(1) With 100 parts by weight of a polyolefin-based resin, 120 parts by weight to 240 parts by weight of a pore forming agent (calcium carbonate having an average particle diameter of 0.1 μm) was kneaded, and a resultant product was filtered through a metal gauze having a nominal mesh size of 50 μm, so that a mixture was obtained.
(2) The mixture obtained in (1) above was formed into a film.
(3) From the film obtained in the (2) above, the pore forming agent was removed.
(4) The film obtained in (3) above was stretched, so that a porous film (separator) was obtained.

### Example 1

MaxEye.Color manufactured by FUTEC INC., which includes a color camera, was used to detect defects in the porous film obtained in Production Example 1. First, the defects were detected on the basis of the amount of light that was transmitted. Specifically, the defects were binarized into bright defects having a light transmission amount of not less than 40 on the brighter side and dark defects having a light transmission amount of not less than 40 on the darker side. Of these defects, defects having a length of not shorter than 100 μm in the MD of the porous film and having a length of not shorter than 50 μm in the TD of the porous film were extracted (primary determining step). Next, the color information of the defects was obtained, and hue, chroma, and lightness were calculated (color determining step). On the basis of the numerical values of the hue, the chroma, and the lightness, the defects were distinguished (secondary determining step). In Example 1, the defects were distinguished under the conditions in which the hue was set to 10 to 49, the chroma was set to 0 to 100, and the lightness was set to 0 to 100 as parameters of a red defect. Among the dark defects and the bright defects, defects satisfying the parameters were determined as red defects. Among the dark defects, defects not satisfying the parameters were determined as black defects. The light transmission amount is represented in 127 levels on the brighter side and 127 levels on the darker side, with 0 being the center of the 256 levels in an 8-bit grayscale. The hue, the chroma, and the lightness are represented by the HSV color space. The hue is represented in values of 0 to 359, where red is 0 and light blue is 180. The chroma is represented in values of 0 to 100, where the achromatic color is 0 and the pure color is 100. The lightness is represented in values of 0 to 100, where the darkest black is 0 and the brightest white is 100.

### Example 2

The defects were distinguished as in Example 1 except that the hue was set to 0 to 49, the chroma was set to 25 to 58, and the lightness was set to 0 to 100 as parameters of a red defect.

### Example 3

The defects were distinguished as in Example 1 except that the hue was set to 10 to 49, the chroma was set to 0 to 100, and the lightness was set to 30 to 50 as parameter of a red defect.

### Example 4

The defects were distinguished as in Example 1 except that the hue was set to 20 to 49, the chroma was set to 25 to 58, and the lightness was set to 30 to 50 as parameters of a red defect.

### Example 5

The defects were distinguished as in Example 1 except that the hue was set to 10 to 49, the chroma was set to 25 to 58, and the lightness was set to 30 to 50 as parameters of a red defect.

### Example 6

The defects were distinguished as in Example 1 except that (i) the hue was set to 10 to 49, the chroma was set to 25 to 58, and the lightness was set to 30 to 50 as parameters of a red defect and (ii) a defect was determined as a red-white defect when, in the defect, the area (bright area) that exhibits a value of not less than 40 on the brighter side in terms of brightness defined by the above-described 8-bit grayscale was not less than 1 μm².

<Success Rate in Recognition>

With use of a digital microscope (VHX-5000 manufactured by Keyence Corporation), the black defects, the red defects, and the red-white defects in the porous film were distinguished in advance. Specifically, a defect that contained no void was regarded as a black defect, a defect that contained a void having a maximum width of not more than 10 μm was regarded as a red defect, and a defect that contained a void having a maximum width of over 10 μm was regarded as a red-white defect.

The porous films were inspected by the methods in Examples, and when the type of defect was properly recognized, it was regarded as “successful recognition”, and when the type of defect was falsely recognized, it was regarded as “failed recognition”. For each of black defects, red defects, and red-white defects, the recognition success rate was determined by the following formula:

Recognition success rate=the number of defects successfully recognized/the number of defects distinguished by a digital microscope×100

For example, 13 black defects were checked with use of a digital microscope in advance, and were inspected with use of a color camera. Then, when 10 black defects and 3 red defects were recognized, the recognition success rate was determined as 77% (=10/13×100).

<Evaluation Results>

The evaluation results are shown in Table 1.

TABLE 1

| | | | | | Success rate in recognition | | |
|---|---|---|---|---|---|---|---|
| | Color parameter (red/black) | | | Red/red-white | | | Red-white |
| | Hue | Chroma | Lightness | Bright area | Black defect | Red defect | defect |
| Example 1 | 10 to 49 | 0 to 100 | 0 to 100 | Not set | 70% | 100% | 0% |
| Example 2 | 0 to 49 | 25 to 58 | 0 to 100 | Not set | 72% | 100% | 0% |
| Example 3 | 10 to 49 | 0 to 100 | 30 to 50 | Not set | 77% | 100% | 0% |
| Example 4 | 20 to 49 | 25 to 58 | 30 to 50 | Not set | 100% | 94% | 0% |
| Example 5 | 10 to 49 | 25 to 58 | 30 to 50 | Not set | 100% | 100% | 0% |
| Example 6 | 10 to 49 | 25 to 58 | 30 to 50 | Not less than | 100% | 100% | 100% |
| | | | | 1 μm² | | | |

Although not shown in the table, when the inspection device having a monochromatic camera was used, it was not possible to distinguish between black defects, red defects, and red-white defects. In contrast, in Examples 1 to 6, the color camera was used, so that it was possible to distinguish the defects on the basis of hue, chroma, and lightness. That is, in Examples 1 to 6, because the color camera was used, it was possible to improve the success rate in defect recognition.

In Example 4, it was possible to improve the success rate in black defect recognition in comparison with Examples 1 to 3 by adjusting all of the three parameters of hue, chroma, and lightness. Presumably, however, some of the red defects were falsely recognized as black defects in Example 4 because the numerical range of the hue was reduced in comparison with Examples 1 to 3. In Example 5, the numerical range of the hue was properly adjusted in comparison with Example 4, so that it was possible to improve the success rates in black defect recognition and red defect recognition. In Example 6, it was possible to distinguish the red-white defects on the basis of not only hue, chroma, and lightness but also bright area.

[2. Analysis of Separator]

### Production Example 2

A porous film was prepared by, as described in Japanese Patent No. 5476844, (i) adding a pore forming agent to a polyolefin-based resin, (ii) forming the polyolefin-based resin into a film, and (iii) removing the pore forming agent.

Specifically, the porous film was formed by a production method including the following steps:
(1) With 100 parts by weight of a polyolefin-based resin, 120 parts by weight to 240 parts by weight of a pore forming agent (calcium carbonate having an average particle diameter of 0.1 μm) was kneaded, and a resultant product was filtered through a metal gauze having a nominal mesh size of 32 μm, so that a mixture was obtained.
(2) The mixture obtained in (1) above was melted and extruded, and filtered again through a metal gauze having a nominal mesh size of 50 μm, and then formed into a film.
(3) From the film obtained in the (2) above, the pore forming agent was removed.
(4) The film obtained in (3) above was stretched, so that a porous film (separator) was obtained.

### Production Example 3

Defects in the porous film obtained in Production Example 2 were detected by the inspection method in Example 6. The detected red-white defects were removed, so that a separator was obtained.

### Production Example 4

A porous film was prepared by, as described in Japanese Patent No. 5476844, (i) adding a pore forming agent to a polyolefin-based resin, (ii) forming the polyolefin-based resin into a film, and (iii) removing the pore forming agent.

Specifically, the porous film was formed by a production method including the following steps:
(1) With 100 parts by weight of a polyolefin-based resin, 120 parts by weight to 240 parts by weight of a pore forming agent (calcium carbonate having an average particle diameter of 0.1 μm) was kneaded, and a resultant product was filtered through a metal gauze having a nominal mesh size of 34 μm, so that a mixture was obtained.
(2) The mixture obtained in (1) above was melted and extruded, and filtered again through a metal gauze having a nominal mesh size of 32 μm, and then formed into a film.
(3) From the film obtained in the (2) above, the pore forming agent was removed.
(4) The film obtained in (3) above was stretched, so that a porous film (separator) was obtained.
(5) The defects in the porous film obtained in (4) above were detected by the inspection method in Example 6. It was confirmed that the void sizes in the red-white defects detected were in the range of 10 μm to 400 μm.

<Voltage Withstand Characteristics>

A roll was prepared by, with use of a winding device, winding an NCM positive electrode, the separator, and an artificial graphite negative electrode so that the NCM positive electrode, the separator, and the artificial graphite negative electrode were laminated in this order. The “NCM” refers to a nickel-cobalt-manganese oxide.

A terminal of the roll was connected to a voltage withstanding, insulation resistance tester (TOS9200 manufactured by Kikusui Electronics Corp.). The voltage was applied to the roll, and was increased at a rate of 25 V/sec. The voltage at which a short circuit occurred was recorded. A roll, in which a short circuit occurred at less than 1.2 kV, was determined as low voltage-withstanding. 18 rolls were tested in Production Examples 2 and 3, and the percentage of rolls determined as low voltage-withstanding was calculated.

<Evaluation Results>

The evaluation results in Production Examples 2 and 3 are shown in Table 2.

TABLE 2

| | Number of | Percentage of |
|---|---|---|
| | red-white defects | low voltage- |
| | per square meter | withstanding |
| Production Example 2 | 2 | 22% |
| (before removal of red-white defects) | | |
| Production Example 3 | 0 | 0% |
| (after removal of red-white defects) | | |

It was found that the separator of Production Example 3, in which the red-white defects were removed by the inspection method in accordance with an embodiment of the present invention, was improved in terms of voltage withstand characteristics in comparison with the separator of Production Example 2 in which the red-white defects were not removed.

The evaluation results of Production Examples 1 and 4 are shown in Table 3.

TABLE 3

| | | Presence/absence of low |
|---|---|---|
| | | voltage-withstanding |
| | Void size | part in winding test |
| Production Example 1 | 480 μm | Yes |
| Production Example 4 | 350 μm | No |

In Production Examples 1 and 4, a void size was obtained, which was the maximum linear distance measured between two points of a void in the red-white defect detected by the inspection method in accordance with Example 6.

The separator of Production Example 1, which contained a red-white defect having a void size of 480 μm was subjected to a withstand voltage test. This caused the occurrence of a short circuit at less than 1.2 kV. In the case of the separator of Production Example 4 which contained a red-white defect having a void size of 350 μm, no short circuit occurred at less than 1.2 kV.

### INDUSTRIAL APPLICABILITY

An aspect of the present invention can be used in production of a nonaqueous electrolyte secondary battery separator.

### REFERENCE SIGNS LIST

1 Color camera

2 Determining section

10 Polyolefin porous film

15 Inspection device

20 Porous layer

30 Foreign substance

100 Production device

1. A method for inspecting a nonaqueous electrolyte secondary battery separator that includes a polyolefin porous film,
said method comprising the step of:
detecting a defect in the polyolefin porous film with use of a color camera.

2. The method according to claim 1, wherein
it is determined whether or not at least one selected from the group consisting of hue, chroma, and lightness of the defect that is detected in the detecting falls within a predetermined range.

3. The method according to claim 2, wherein
it is determined whether or not a region of the defect that is detected in the detecting, which region transmits light therethrough in an amount of not less than a predetermined threshold, has an area which falls within a predetermined range.

4. A method for producing a nonaqueous electrolyte secondary battery separator,
said method comprising the step of:
detecting a defect by the method according to claim 1; and
removing the defect.

5. An inspection device which inspects a nonaqueous electrolyte secondary battery separator including a polyolefin porous film,
said inspection device comprising:
a detecting section which detects a defect in the polyolefin porous film with use of a color camera.

6. The inspection device according to claim 5, further comprising:
a determining section which determines whether or not at least one selected from the group consisting of hue, chroma, and lightness of the defect that is detected by the detecting section falls within a predetermined range.

7. The inspection device according to claim 6, wherein
the determining section determines whether or not a region of the defect that is detected by the detecting section, which region transmits light therethrough in an amount of not less than a predetermined threshold, has an area falling within a predetermined range.

8. A nonaqueous electrolyte secondary battery separator production device comprising:
the inspection device according to claim 5.

9. A nonaqueous electrolyte secondary battery separator comprising:
a polyolefin porous film in which the number of defects satisfying the following (i) to (iv) is equal to or more than 0 and less than 2 per square meter:
(i) hue, represented in values of 0 to 359 in an HSV color space that represents red as 0 and light blue as 180, is 10 to 49.
(ii) chroma, represented in values of 0 to 100 in an HSV color space that represents an achromatic color as 0 and a pure color as 100, is 25 to 58.
(iii) lightness, represented in values of 0 to 100 in an HSV color space that represents darkest black as 0 and brightest white as 100, is 30 to 50.
(iv) an area of the following region is not less than 1 μm²: a region that transmits light in an amount of not less than 40 on a brighter side, in terms of an 8-bit grayscale where the brighter side and a darker side are each represented in 127 levels with 0 being a center of the 256 levels.

10. A nonaqueous electrolyte secondary battery separator comprising:
a polyolefin porous film which contains, more inwardly than an outer surface, a defect containing a void that has a size of 10 μm to 400 μm.

11. A nonaqueous electrolyte secondary battery laminated separator comprising:
the nonaqueous electrolyte secondary battery separator according to claim 9; and
a porous layer which is formed on at least one surface of the nonaqueous electrolyte secondary battery separator and which contains at least one resin selected from the group consisting of a (meth)acrylate-based resin, a fluorine-containing resin, a polyamide-based resin, a polyimide-based resin, a polyester-based resin, and a water-soluble polymer.

12. The nonaqueous electrolyte secondary battery laminated separator according to claim 11, wherein
the polyamide-based resin is an aramid resin.

13. A nonaqueous electrolyte secondary battery laminated separator comprising:
the nonaqueous electrolyte secondary battery separator according to claim 10; and
a porous layer which is formed on at least one surface of the nonaqueous electrolyte secondary battery separator and which contains at least one resin selected from the group consisting of a (meth)acrylate-based resin, a fluorine-containing resin, a polyamide-based resin, a polyimide-based resin, a polyester-based resin, and a water-soluble polymer.

14. The nonaqueous electrolyte secondary battery laminated separator according to claim 13, wherein
the polyamide-based resin is an aramid resin.
